(19) United States
(12) Patent Application Publication
(10) Pub. No.: US 2009/0070224 A1
(43) Pub. Date: Mar. 12, 2009

(54) Product and method for promoting a person, place or thing

(75) Inventors: Lori Mottlowitz, Highland Park, IL (US); Jill Manzara, Northbrook, IL (US)

Correspondence Address: FACTOR & LAKE, LTD, 1327 W. WASHINGTON BLVD., SUITE 5G/H, CHICAGO, IL, 60607, US

(73) Assignee: VIVA ENTERPRISES LLC, Northbrook, IL (US)

(21) Appl. No.: 12/231,892

(22) Filed: Sep. 5, 2008

Related U.S. Application Data
(63) Continuation of application No. 11/659,932, now abandoned.
(60) Provisional application No. 60/600,766, filed on Aug. 11, 2004.

(51) Int. Cl. G06Q 30/00; B28B 1/00

(52) U.S. Cl. 705/14; 264/679

(57) ABSTRACT

The present invention is directed to a method for promoting a person, place or thing. The method includes forming a design into clay, and then firing the clay into final form. The design is associated with the person, place or thing such that a third party, when viewing the design, will associate the design with the person, place or thing being promoted. Preferably, the design is formed using a clay cane method, including the steps of assembling a clay cane with a design in cross-section, rolling the clay cane to a predetermined diameter, and then removing sections of the clay cane for later firing.

### CROSS-REFERENCE TO RELATED APPLICATIONS

This application is a continuation of U.S. patent application Ser. No. 11/659,932 filed Feb. 9, 2007, which is a national phase of and claims priority to PCT/US05/28476 filed Aug. 11, 2005, which claims priority to Provisional Patent Application Ser. No. 60/600,766 filed Aug. 11, 2004.

### BACKGROUND OF THE INVENTION

1. Field of the Invention

The present invention relates to an improved method and product for promoting a person, place or thing, and specifically to clay-based products that incorporate logos, trademarks, trade names, team colors and the like, as well as methods for making the same.

2. Description of Related Art

Promotional materials and products have been used for years to help promote movies, sports teams, civic pride, books as well as others. Typically, the materials and products are manufactured having a design, picture, trademark or logo, sometimes in combination with words or symbols, that represent the promoted item to the general consuming public. The products are either given away or sold to the consuming public, with hopes that they will wear, use and enjoy the products in public and otherwise. In doing so, of course, the visibility of the promoted item is increased, and in turns the marketing of that item.

In order to optimize the distribution of the promotional products, the costs associated with the manufacture of these products become of paramount importance. To that end, conventional promotional materials are manufactured using low-cost materials such as plastic and the like.

One preferred medium for promotional materials and products is clay. Clay has a look, feel and texture that is preferred by customers, such that the wearability, use and exposure of the promotional items would be increased. Conventionally, however, clay products have been too expensive to mass manufacture. The clay manufacturing process involves the preparation of a wet clay material, or “slip,” which is formed into a final product, dried, and then fired. Adding a design to the final product, in turn, adds another step to this process. As such, despite the attractive nature of clay as a medium for promotional materials, conventional manufacturing processes have not utilized clay in a mass-market or promotional basis.

It is an object of this invention, therefore, to provide an improved promotional product, utilizing the desirous clay medium, as well as a simple and effective process for manufacturing such a product. This and other objects will become apparent to one of ordinary skill in the art in view of the specification, claims and drawings appended hereto.

### SUMMARY OF THE INVENTION

The present invention is an improved method for promoting a person, place or thing, which method includes the steps of (1) forming a design into clay, wherein the design is associated with the person, place or thing, and (2) firing the clay into a final product, wherein the final product may be distributed to third parties to help promote the person, place or thing. Preferably, the design is formed into clay by assembling a clay cane having the design at least in cross-section, the clay cane having a length and a diameter, longitudinally rolling the clay cane to reduce the diameter of the clay cane and increase the length of the clay cane, which rolling is continued until the diameter reaches a predetermined diameter. After the predetermined diameter is reached, sections of the clay cane may be removed, wherein each section includes the design at least in cross-section. The section could be a cross-section of a clay cane, for example.

The clay with the design may, in one embodiment, be applied to an object prior to firing. The object could comprise a clay support, such as a clay bead or a clay chip, depending upon the desired shape of the final product. For example, the final product could be a necklace bead, a clothing accessory, an earring, a body ring, a hair accessory, a cell-phone accessory a key-chain bead, and a clothing dangle.

The design formed into the clay can be a variety of forms, including a raised sculpture, a sculpture in relief, an etching, a flat colored design, and a flat black and white design. In one preferred embodiment, the flat colored design comprises two or more colors, wherein the two or more colors are associated with the person, place or thing being promoted.

Before firing, the clay product can be finished and finalized, by adding a glaze or other finishing material.

### BRIEF DESCRIPTION OF THE DRAWINGS

FIGS. 1a-1e are perspective views of various design forms in accordance with the present invention;

FIG. 1a is a perspective view of a raised sculpture design;

FIG. 1b is a perspective view of a recessed sculpture design;

FIG. 1c is a perspective view of an etched design;

FIG. 1d is a perspective view of a flat, colored design;

FIG. 1e is a perspective view of a flat, black and white design;

FIG. 2 is a top view of a preferred embodiment of a flat, colored design;

FIGS. 3a-3f are various views of the steps in a clay-cane technique;

FIG. 3a is a perspective view of a starter design for a clay cane;

FIG. 3b is a perspective view of a built clay cane;

FIG. 3c is a perspective view of a partially-built clay cane;

FIG. 3d is a perspective view of another step in a partially-built clay cane;

FIG. 3e is a side view of a clay cane prior to longitudinal rolling;

FIG. 3f is a side view of a clay cane after longitudinal rolling;

FIG. 3g is a top view of a cross-sectional cut out of a rolled clay cane;

FIG. 4 is a perspective view of the application of cross-sectional cut outs to a clay base, such as a clay bead;

FIGS. 5a-5f are perspective views of various embodiments of final products;

FIG. 5a is a perspective view of a necklace having clay beads strung thereon;

FIG. 5b is a perspective view of a clothing accessory, such as a clay bead for clipping on clothes;

FIG. 5c is a perspective view of an earring or body ring;

FIG. 5d is a perspective view of a hair accessory;

FIG. 5e is a perspective view of a cell-phone accessory, such as a cell-phone dangle;

FIG. 5f is a perspective view of a clothing accent, such as a clothing dangle; and

FIG. 6 is a top view of an adhesive clay accessory.

### DETAILED DESCRIPTION OF THE INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

The present invention comprises a new and improved product and method for promoting a person, place or thing. The product comprises a clay object which includes a design thereon, wherein the design is associated with a person, place or thing that is to be promoted. The use of clay as the medium for the product provides a benefit to the present invention, inasmuch as clay has a look and feel that is desired by both customers and distributors, such that the products made from the clay, and including the design, have a high instance of wear, distribution and use.

Similarly, the method of the invention includes the steps of (1) forming a design into clay, wherein the design is associated with the person, place or thing; and (2) firing the clay to form a final product, wherein the final product may thereafter be distributed to third parties to help promote the person, place or thing.

The product and method of the present invention presumes a pre-selected design or designs that are associated with the person, place or thing. An “associated” design can comprise any letter, letters, word, symbol, picture, color, set of colors, or other type of design that has an affiliation with the person, place or thing being promoted. For example, the associated design could comprise trademarks and trade names of companies, team names and symbols of sporting teams, pictures or popular graphic figures from popular books or movies, names of cities or other locales, and the like.

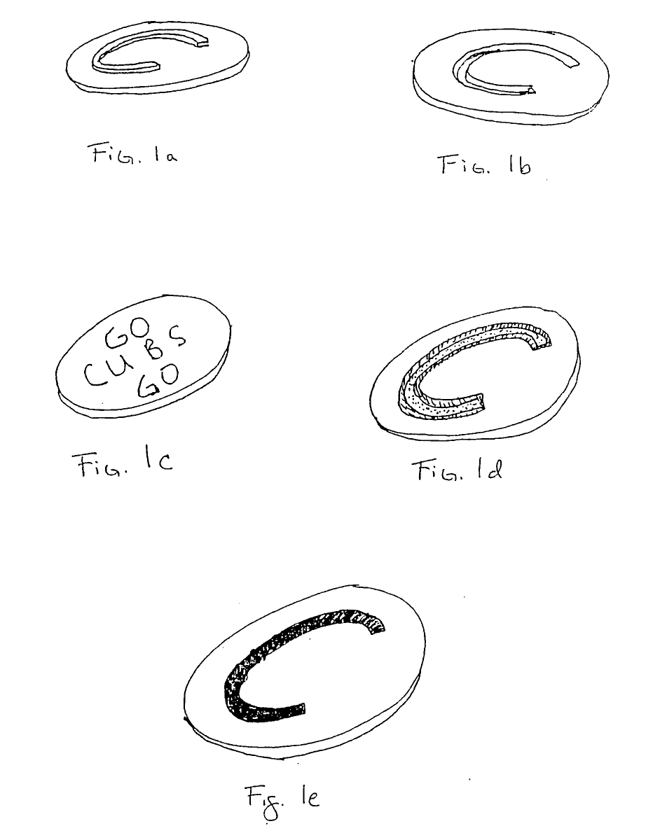

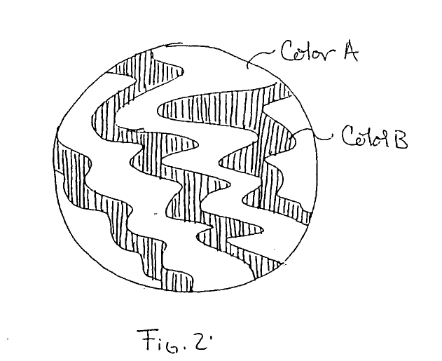

Once the design is selected, it is formed into clay for later firing. The design formed into the clay can be of a variety of design forms, depending upon the requirements and form of the preselected design. For example, and as shown in FIGS. 1a-1e, the design could be a sculpture, either raised (FIG. 1a) or in relief (FIG. 1b), an etching (FIG. 1c), or a flat design of color (FIG. 1d) or black and white (FIG. 1e).

One preferred embodiment of the present invention, shown in FIG. 2, includes forming the design from two or more pre-selected colors (such as Color A and Color B), wherein the colors are directly associated with the person, place or thing being promoted. For example, professional and college sports teams often have two or more colors included in their logos, which become inherently associated with their sports teams. In this preferred embodiment of the invention, the design could comprise a mixture of the two or more colors in any design format, such as a swirl pattern, a striped pattern, or in a logo design. Of course, the two or more colors may be combined into other designs, as would be known to one of ordinary skill in the art.

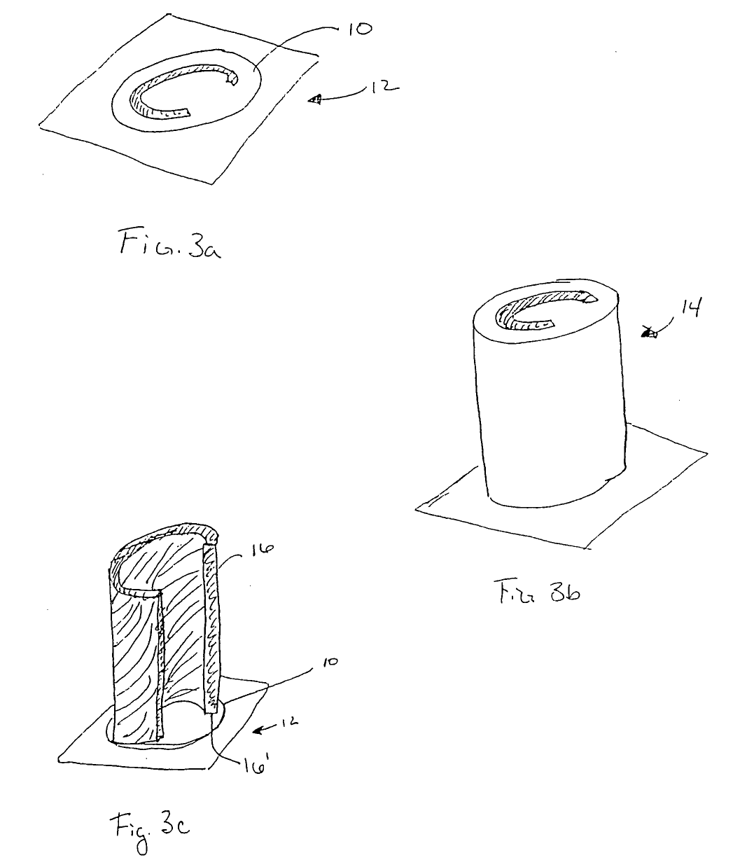

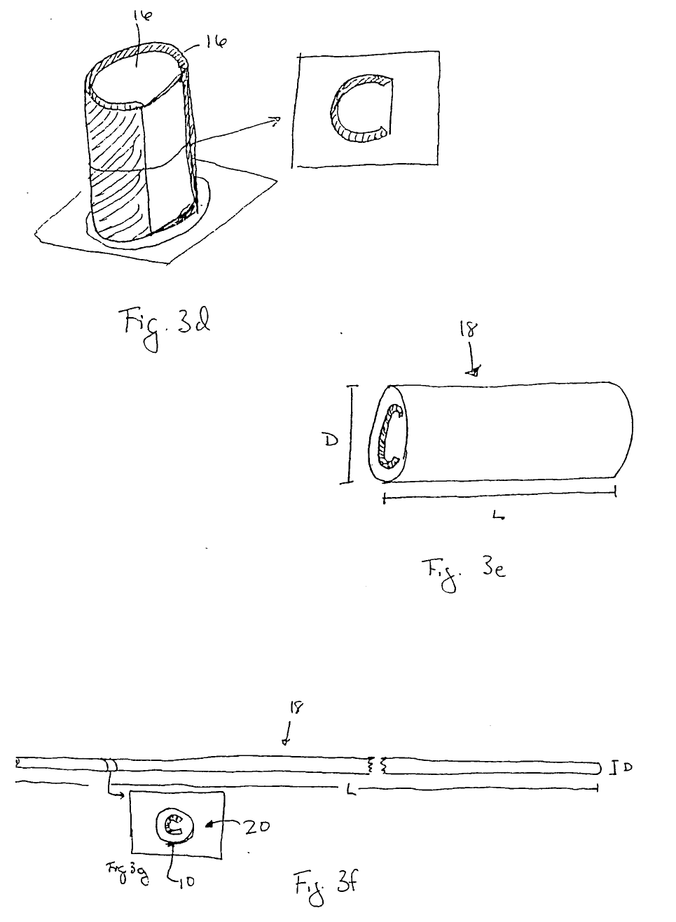

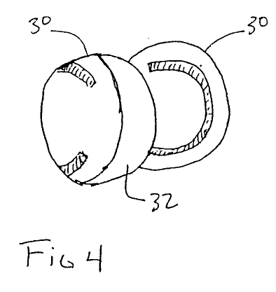

The design can be formed into individual pieces of clay, or can be mass produced by conventional methods. One preferred method of mass-producing a flat design is to utilize a method called a clay-cane technique. The steps of this method are shown generally in FIGS. 3a-3f. In a clay-cane technique, the flat design 10 is first captured on a flat sheet 12, such as paper, as shown in FIG. 3a. Generally, the design 10 should be several times larger than the desired final design, and preferably is enlarged to around 24 inches in diameter. The enlarged design 10 can then be placed on a flat surface, and a clay cane 14 can be built on the enlarged design, such as is shown in FIG. 3b. To build the clay cane 14, clay is applied vertically upwards to the flat sheet in sections as shown in FIG. 3c, for example section 16, corresponding to the portions, such as portion 16′, of the design that they are intended to imitate, to a predetermined height. The sum of the individual sections 16 creates the design 10 design in cross-section, as shown in FIG. 3d, which sections 16 are molded together into a single stack, or clay cane. A clay cane can be several feet in height when completed, depending upon production needs.

After the clay cane 18 is built, the diameter of the clay cane may need to be reduced to produce design pieces having an appropriate diameter for distribution. The diameter of the clay cane 18 may be reduced by longitudinal rolling of the clay cane 18, as shown in FIG. 3e, either by hand or by machine. The rolling reduces the outer diameter (D) of the clay cane 18, and increases the length (L) of the cane 18. Once the desired outer diameter has been achieved, the clay cane 18 may be separated into slices 20, with each slice including the design 10 therein, such as in FIG. 3f.

Regardless of which method is used for forming the design into clay, whether the design is simply formed into clay or the clay-cane technique is used, the result is a pre-fired clay design. Depending upon the desired final form of the clay object, the pre-fired clay design may be fired as is, or a glaze or other finishing material may be added thereto. Alternatively, the pre-fired clay design may be formed into a shape or applied to a structure for firing.

In one preferred embodiment, as shown in FIG. 4, the pre-fired clay design 30 is applied to a clay support, such as a clay bead 32. One or more pre-fired clay designs 30 may be applied as needed. By applying the pre-fired clay design 30 to a clay bead 32, or other object, desirable final product structures can be made, while maintaining the design itself.

As with designs that are fired with application to a support or object, once the prefired clay design 30 is applied to a structure, it may then be finished, such as with a glaze or other finishing material, and before firing the clay into a final product.

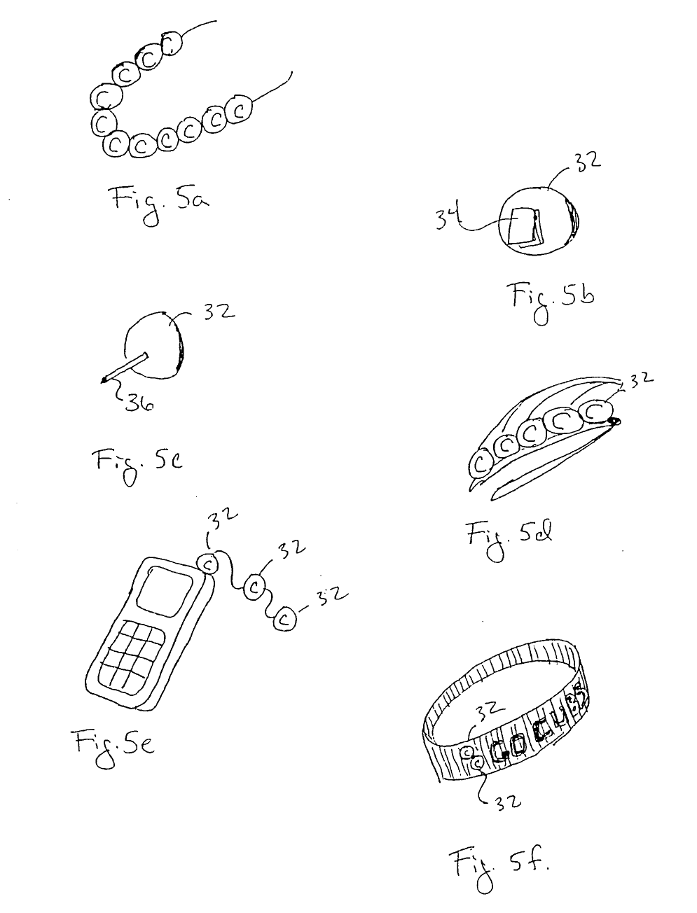

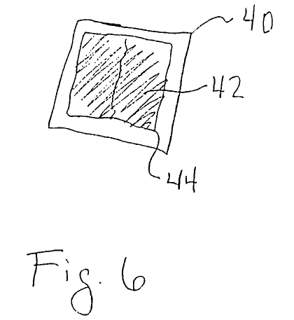

The final product may take on a variety of forms for distribution. Clay beads, for example, such as those shown in FIG. 4, may have holes drilled through their middles, and be strung together on a necklace, such as shown in FIG. 5a. Similarly, strung beads can be used in other capacities as well, such as in key chains, watch bands, bracelets, or other similar wearables. FIG. 5b shows a clay bead 32 with a clip 34 affixed thereto, which clip 34 enables the clay bead 32 to be affixed to clothing and the like. FIG. 5c depicts a clay bead 32 having an earring post 36 affixed on one end, such that the bead may be used as body jewelry. Similarly, beads 32 or other objects may be affixed to hair accessories (FIG. 5d), as a cell-phone accessory (FIG. 5e), and as a clothing dangle, such as a clay bead that can be affixed to shirts, or other clothing items such as a headband (FIG. 5f). Any of these product forms could be used with other final clay structures as well.

Other preferred embodiments could include a final clay product, such as clay chip 40 shown in FIG. 6, having an adhesive 42 on one side, with a removable protector 44 over the adhesive 42. In this embodiment, once the removable protector 44 has been removed from the adhesive 42, the clay chip 40 may be affixed to objects, such as school folders, for decorative purposes.

The clay designs, once formed and fired into a final product, may be distributed to third parties, such as guests at sporting events, visitors to trade shows, or customers at book signings or movie openings. Since the final products include the design, which in turn has a direct association with a person, place or thing being promoted, the distribution and subsequent use of the final products enhances the visibility of the person, place or thing. Because the final products are constructed from clay, the persons who receive the final products are more likely to increase their use and wear the items, so that, in turn, the marketing power of the final products is likewise increased.

It should be emphasized that the above-described embodiments of the present invention, particularly, any “preferred” embodiments, are possible examples of implementations merely set forth for a clear understanding of the principles of the invention. Many variations and modification may be made to the above-described embodiment(s) of the invention without substantially departing from the spirit and principles of the invention. All such modifications are intended to be included herein within the scope of this disclosure and the present invention, and protected by the following claims.

What is claimed is:

1. A method for promoting a person, place or thing, the method comprising the steps of:
forming a design into clay, wherein the design is associated with the person, place or thing; and
firing the clay into a final product;
wherein the final product may be distributed to third parties to help promote the person, place or thing.

2. The method according to claim 1, wherein the step of forming a design comprises the steps of:
assembling a clay cane having the design at least in cross-section, the clay cane having a length and a diameter;
longitudinally rolling the clay cane to reduce the diameter of the clay cane, and increase the length of the clay cane, wherein the step of longitudinally rolling is continued until the diameter reaches a predetermined diameter; and
removing a section of the clay cane, wherein the section includes the design at least in cross-section.

3. The method according to claim 2, wherein the section comprises a cross-section of the clay cane.

4. The method according to claim 1, wherein after the step of forming a design, the method further includes the step of applying the clay having the formed design to an object before firing the clay into a final product.

5. The method according to claim 4, wherein the object comprises a clay support.

6. The method according to claim 5, wherein the clay support comprises a clay bead.

7. The method according to claim 5, wherein the object comprises a clay chip.

8. The method according to claim 1, wherein the design is selected from the group consisting of a raised sculpture, a sculpture in relief, an etching, a flat colored design, and a flat black and white design.

9. The method according to claim 8, wherein the flat colored design comprises two or more colors, wherein the two or more colors are associated with the person, place or thing being promoted.

10. The method according to claim 1, wherein the final product comprises one or more products selected from the group of a necklace bead, a clothing accessory, an earring, a body ring, a hair accessory, a cell-phone accessory, a key-chain, and a clothing dangle.

11. The method according to claim 1, further comprising the step of adding a glaze to the clay with the design prior to the step of firing the clay.

12. A method for promoting a person, place or thing, the method comprising the steps of:
forming a design into clay, wherein the design is associated with the person, place or thing;
the method of forming comprising the steps of:
assembling a clay cane having the design at least in cross-section, the clay cane having a length and a diameter;
longitudinally rolling the clay cane to reduce the diameter of the clay cane, and increase the length of the clay cane, wherein the step of longitudinally rolling is continued until the diameter reaches a predetermined diameter; and
removing a section of the clay cane, wherein the section includes the design at least in cross-section; and
firing the section into a final product;
wherein the final product may be distributed to third parties to help promote the person, place or thing.

13. The method according to claim 12, wherein after the step of forming a design, the method further includes the step of applying the clay having the formed design to an object before firing the clay into a final product.

14. The method according to claim 13, wherein the object comprises a clay support.

15. The method according to claim 14, wherein the clay support comprises a clay bead.

16. The method according to claim 14, wherein the object comprises a clay chip.

17. The method according to claim 12, wherein the design is selected from the group consisting of a raised sculpture, a sculpture in relief, an etching, a flat colored design, and a flat black and white design.

18. The method according to claim 17, wherein the flat colored design comprises two or more colors, wherein the two or more colors are associated with the person, place or thing being promoted.

19. The method according to claim 12, wherein the final product comprises one or more products selected from the group of a necklace bead, a clothing accessory, an earring, a body ring, a hair accessory, a cell-phone accessory, a key-chain, and a clothing dangle.

20. A method for promoting a person, place or thing, the method comprising the steps of:
forming a design into clay, wherein the design is associated with the person, place or thing;
the method of forming comprising the steps of:
assembling a clay cane having the design at least in cross-section, the clay cane having a length and a diameter;
longitudinally rolling the clay cane to reduce the diameter of the clay cane, and increase the length of the clay cane, wherein the step of longitudinally rolling is continued until the diameter reaches a predetermined diameter; and
removing a section of the clay cane, wherein the section includes the design at least in cross-section;
applying at least one section to a clay support; and
firing the section into a final product;
wherein the final product may be distributed to third parties to help promote the person, place or thing.
